(19) United States
(12) Patent Application Publication
(10) Pub. No.: US 2023/0308514 A1
(43) Pub. Date: Sep. 28, 2023

(54) INPUT UNIT, CONTROL SYSTEM, COMMUNICATION METHOD, AND RECORDING MEDIUM

(71) Applicant: Mitsubishi Electric Corporation, Tokyo (JP)

(72) Inventor: Tomoya FURUKAWA, Tokyo (JP)

(73) Assignee: Mitsubishi Electric Corporation, Tokyo (JP)

(21) Appl. No.: 18/035,517

(22) PCT Filed: Jun. 25, 2021
(86) PCT No.: PCT/JP2021/024084

§ 371 Date: May 5, 2023

(51) Int. Cl. G05B 19/05; H04L 67/12

(52) U.S. Cl. CPC G05B 19/054; H04L 67/12; G05B 2219/1105

(57) ABSTRACT

An input unit (20) is connectable to a programmable controller (10) and an output unit (30) to share a shared time with the programmable controller (10) and the output unit (30). The input unit (20) includes a data sharer (220) that shares, in a periodic time segment defined by the shared time, data in a storage area (214) with the programmable controller (10) and the output unit (30), and an input (240) that acquires input information input from an input device (20A). The data sharer (220) transmits, in the periodic time segment, transmission information to the output unit (30). The transmission information is the input information or indicates a result of a predetermined computation process performed on the input information.

### TECHNICAL FIELD

The present disclosure relates to an input unit, a control system, a communication method, and a program.

### BACKGROUND ART

At the sites of factory automation (FA), a controller controls an output device in accordance with the input state of an input device, typically a sensor. For such control, control systems have been developed recently with less wiring and more intelligence. A control system may include multiple devices to serve as a master station and a slave station that operate in coordination with each other. The device as the master station controls and manages a slave device, whereas a device as the slave station operates as the slave device under control by the master station. Such a control system includes, for example, a controller including the master station connected to an input device and an output device through the slave station. The master station and the slave station form a network, on which the controller controls the output device through the slave station in accordance with an input state acquired through the slave station.

Such control performed by the controller through the slave station involves a communication delay. The control is thus to be performed at high speed in accordance with the input state of the input device. For the input device and the output device connected to a single slave station, the single slave station may perform a control process in place of the controller including the master station to avoid a communication delay and allow high-speed control. Techniques have also been developed for high-speed control over communication between different slave stations to which the input device and the output device are connected (see, for example, Patent Literature 1).

Patent Literature 1 describes use of a slave program separate from a control program to avoid exceeding an allowable time delay and also describes generation of slave-to-slave communication setting information for a slave controller to execute the slave program. The slave controller acquires input-output information from another slave controller through slave-to-slave communication and executes a slave program for this controller.

### CITATION LIST

### Patent Literature

Patent Literature 1: International Publication No. WO 2012/090291

### SUMMARY OF INVENTION

### Technical Problem

Although the technique in Patent Literature 1 may avoid a communication delay resulting from transmitting information through the master station, the master station cannot detect completion of data transmission from one slave station to another slave station within a predetermined time. This structure may not allow processing to be complete within the predetermined time. The transmission of data between devices as slave stations is to be more stable and to be performed at higher speed.

In response to the above circumstances, an objective of the present disclosure is to allow more stable transmission of data between slave stations at higher speed.

### Solution to Problem

An input unit according to an aspect of the present disclosure is connectable to a programmable controller and an output unit through a network and to an input device to share a shared time with the programmable controller and the output unit. The input unit includes first data sharing means for transmitting, in a periodic time segment defined by the shared time, data stored in an area allocated to the input unit in a first storage area in first storage means to the programmable controller and the output unit, receiving data from each of the programmable controller and the output unit, and storing the received data into an area allocated to each of the programmable controller and the output unit in the first storage area to share the data in the first storage area with the programmable controller and the output unit, and an input means for acquiring input information input from the input device and storing the acquired input information into the area allocated to the input unit in the first storage area. The first data sharing means transmits, in the periodic time segment, transmission information to the output unit. The transmission information is the input information or indicates a result of a predetermined computation process performed on the input information.

### Advantageous Effects of Invention

In the structure according to the above aspect of the present disclosure, data sharing means shares data with a programmable controller and an output unit in each periodic time segment and transmits transmission information in each of the time segments. Thus, the transmission of transmission information between an input unit and the output unit corresponding to slave stations can be complete in the time segments. This allows more stable transmission of data between the slave stations at higher speed.

### BRIEF DESCRIPTION OF DRAWINGS

FIG. 1 is a block diagram of a control system according to Embodiment 1;

FIG. 2 is a block diagram of an FA device in Embodiment 1, illustrating the hardware configuration;

FIG. 3 is a diagram describing a time-division communication scheme in Embodiment 1;

FIG. 4 is a diagram describing cyclic transmission in Embodiment 1;

FIG. 5 is a functional block diagram of a PLC, an input unit, and an output unit in Embodiment 1;

FIG. 6 is a diagram of example setting information in Embodiment 1;

FIG. 7 is a diagram describing transmission of transmission information in Embodiment 1;

FIG. 8 is a flowchart of a control process in Embodiment 1;

FIG. 9 is a diagram describing a first comparative example;

FIG. 10 is a diagram describing a second comparative example;

FIG. 11 is a diagram describing a third comparative example;

FIG. 12 is a block diagram of a control system according to Embodiment 2;

FIG. 13 is a functional block diagram of a PLC, an input unit, and an output unit in Embodiment 2;

FIG. 14 is a diagram of an example control program in Embodiment 2;

FIG. 15 is a diagram of example history information in Embodiment 2; and

FIG. 16 is a flowchart of a control setting process in Embodiment 2.

### DESCRIPTION OF EMBODIMENTS

A control system 1000 according to one or more embodiments of the present disclosure is described below in detail with reference to the drawings.

### Embodiment 1

The control system 1000 according to the present embodiment corresponds to a part of a factory automation (FA) system installed at a factory. The FA system may be, for example, a system for operating a production line, an inspection line, or a machining line, or another processing system. The control system 1000 includes a programmable logic controller (PLC) 10 for distributing a shared time in the control system 1000, an input unit 21 as a slave station connected to input devices 21a and 21b, an input unit 22 as a slave station connected to input devices 22a and 22b, and an output unit 30 as a slave station connected to an output device 30a. Each of the input units 21 and 22 is hereafter referred to as an input unit 20 as appropriate. Each of the input devices 21a, 21b, 22a, and 22b is hereafter referred to as an input device 20A as appropriate. In the control system 1000, the PLC 10 controls the output device 30a in accordance with the state of the input device 20A. The input unit 20 and the output unit 30 perform a predetermined control process in place of the PLC 10.

The PLC 10, the input unit 20, and the output unit 30 are connected with an industrial network 40 to communicate with one another. The network 40 may be a local area network (LAN). An Ethernet frame is transmitted through the network 40. The network 40 may be a bus, line, star, or ring network.

The input unit 21 is connected to the input devices 21a and 21b with a transmission path 51. The input unit 22 is connected to the input devices 22a and 22b with a transmission path 52. The output unit 30 is connected to the output device 30a with a transmission path 60. The transmission paths 51, 52, and 60 may each be an electric wire for transmitting an analog current signal or an analog voltage signal, or a communication line for transmitting digital data through serial communication.

For example, the input device 20A is typically a sensor, a button, a switch, a microphone, or a camera. The input device 20A outputs information to the input unit 20 in accordance with an external situation. For example, the input device 21a that is an infrared sensor normally outputs a low-level voltage signal, and outputs a high-level voltage signal upon detection of infrared rays with a strength higher than a predetermined strength.

For example, the output device 30a is typically a valve, a relay, an actuator, or a robot. The output device 30a operates based on information output from the output unit 30. For example, the output device 30a that is an actuator operates when a high-level current signal is output from the output unit 30, and stops operating when a low-level current signal is output.

The PLC 10 is a programmable controller. The PLC 10 provides a control command based on information from the input unit 20 to the output unit 30. The PLC 10 includes a central processing unit (CPU) 11 for executing a ladder program defined by a user to perform a control process, and a network unit 12 as a master station. The CPU 11 is connected to the network unit 12 with a system bus 19. The CPU 11 and the network unit 12 are installed on a base (not illustrated) including the system bus 19 to serve as a programmable controller.

The CPU 11 acquires information about the input device 20A from the input unit 20 through the network unit 12, and controls the output device 30a through the network unit 12 and the output unit 30. For example, the PLC 10 normally operates the output device 30a that is an actuator, and stops the output device 30a when the input device 21a detects abnormal infrared rays.

In the control system 1000, the input unit 20 corresponds to a component for inputting information indicating the state of the input device 20A into the PLC 10. In the control system 1000, the output unit 30 corresponds to a component for outputting a control command from the PLC 10 to the output device 30a. For the input device 20A and the output device 30a that are near the PLC 10, an input-output unit in the PLC 10 is normally connected to the input device 20A and to the output device 30a. In contrast, for the input unit 20 and the output unit 30 communicating with the PLC 10 through the network 40, the input device 20A and the output device 30a may be remotely connected to the PLC 10 to perform a control process.

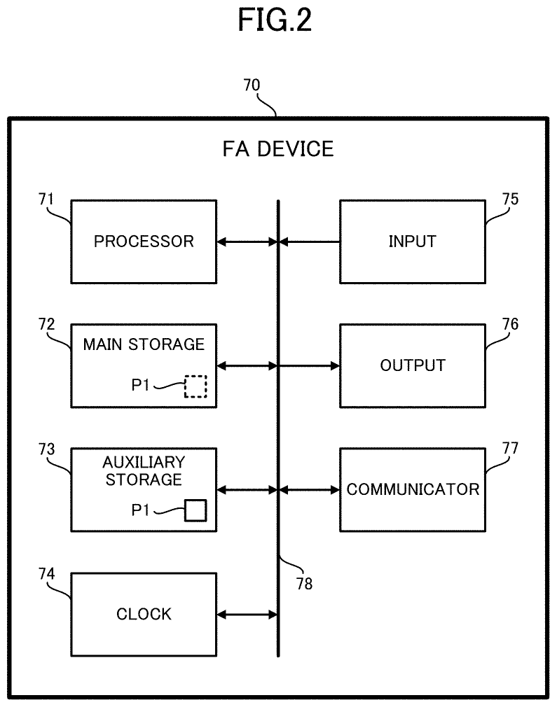

FIG. 2 illustrates the hardware components of an FA device 70 corresponding to the CPU 11, the network unit 12, the input unit 20, and the output unit 30. The FA device 70 includes, as the hardware components, a processor 71, a main storage 72, an auxiliary storage 73, a clock 74, an input 75, an output 76, and a communicator 77. The main storage 72, the auxiliary storage 73, the clock 74, the input 75, the output 76, and the communicator 77 are connected to the processor 71 with an internal bus 78.

FIG. 2 illustrates the hardware components of the FA device 70 that is a computer. The FA device 70 may include another hardware component not illustrated in FIG. 2. For example, the input unit 20 may include a terminal for receiving a voltage signal from the input device 20A.

The processor 71 includes a CPU or a micro processing unit (MPU) as an integrated circuit. The processor 71 executes a program P1 stored in the auxiliary storage 73 to implement various functions of the FA device 70 and perform processes described later.

The main storage 72 includes a random-access memory (RAM). The main storage 72 stores the program P1 loaded from the auxiliary storage 73. The main storage 72 is used as a work area by the processor 71.

The auxiliary storage 73 includes a nonvolatile memory such as an electrically erasable programmable read-only memory (EEPROM) and a hard disk drive (HDD). The auxiliary storage 73 stores, in addition to the program P1, various data items used in the processing performed by the processor 71. The auxiliary storage 73 provides data usable by the processor 71 to the processor 71 as instructed by the processor 71, and stores data provided by the processor 71.

The clock 74 includes, for example, a clock generator including a quartz resonator, a silicon resonator, a quartz oscillator, or another oscillator circuit. The clock 74 generates a clock signal based on a clock generated by the clock generator, and outputs the clock signal. The clock signal includes a clock pulse and is used by the processor 71 to measure time by counting the number of times the clock pulse rises using a built-in hardware device or through software processing.

The input 75 includes input devices, typically input keys and a pointing device. The input 75 acquires information input into the FA device 70 by the user and provides the acquired information to the processor 71.

The output 76 includes output devices, typically a light-emitting diode (LED), a liquid crystal display (LCD), or a speaker. The output 76 presents various items of information to the user as instructed by the processor 71.

The communicator 77 includes a network interface circuit for transmitting or receiving an Ethernet frame with external devices. The communicator 77 receives a signal from outside and outputs data carried by the signal to the processor 71. The communicator 77 also transmits a signal carrying data output from the processor 71 to an external device. Although FIG. 2 illustrates a single communicator 77, the FA device 70 may include multiple communicators 77 for connection to different transmission paths.

A time-division communication scheme for the PCL 10, the input unit 20, and the output unit 30 is now described.

The PLC 10, the input unit 20, and the output unit 30 are synchronized through the network 40. More specifically, each of the PLC 10, the input unit 20, and the output unit 30 shares time with the other devices in accordance with a synchronous protocol. The synchronous protocol is used to synchronize the devices on a communication network accurately. When, for example, IEEE 802.1AS is used as the synchronous protocol, a grand master corresponding to one node on the network periodically distributes an accurate reference clock through the communication network. When data is transmitted back to the grand master from a subordinate node, a communication delay is measured. The subordinate node acquires a reference clock resulting from correction of the communication delay. Thus, the time with the communication delay being corrected is shared.

Time sharing and synchronization among multiple devices refer to synchronization of clocks included in the respective devices. When the clocks in the respective devices measure the same time and share the measured time with one another, the devices are synchronized. The time shared between the devices is hereafter referred to as shared time.

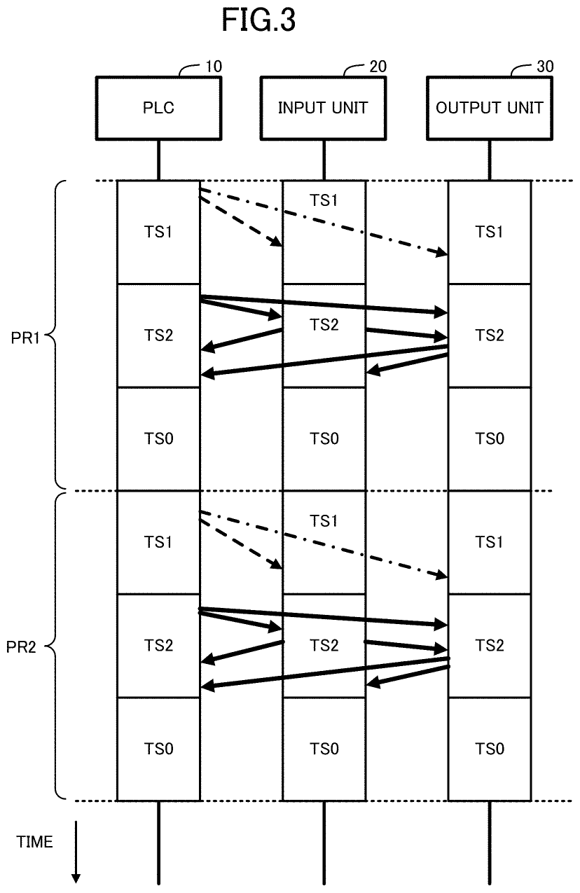

The PLC 10, the input unit 20, and the output unit 30 transmit or receive data at the shared time based on a predetermined schedule. More specifically, as illustrated in FIG. 3, the PLC 10, the input unit 20, and the output unit 30 communicate using time-division multiplexing in each of periods PR1 and PR2 with a length predetermined in accordance with the shared time.

The periods PR1 and PR2 are adjacent to each other. More specifically, the period PR2 immediately follows the period PR1, with the end time of the period PR1 coincident with the start time of the period PR2. Although FIG. 3 illustrates the two periods PR1 and PR2, periods equivalent to the periods PR1 and PR2 periodically precede the period PR1 and follow the period PR2.

The periods PR1 and PR2 each include time slots TS1, TS2, and TS0 adjacent to one another. When the time slots TS1, TS2, and TS0 occur in this order in the period PR1 as illustrated in FIG. 3, the start time of the time slot TS1 coincides with the start time of the period PR1, the end time of the time slot TS1 coincides with the start time of the time slot TS2, the end time of the time slot TS2 coincides with the start time of the time slot TS0, and the end time of the time slot TS0 coincides with the end time of the period PR1. The time slot TS1 in the period PR2 immediately follows the time slot TS0 in the period PR1.

The time slots TS1, TS2, and TS0 are time segments for transmitting different types of predefined data. In detail, the time slot TS0 to TS2 are defined for performing communication with respective predetermined modes, channels, or protocols.

For example, in the time slot TS1, data for synchronizing time with the synchronous protocol is transmitted from the PLC 10 corresponding to the grand master to the input unit 20 and the output unit 30 corresponding to the subordinate nodes, as indicated by dashed arrows in FIG. 3. In the time slot TS2, data for cyclic transmission is transmitted as indicated by thick arrows in FIG. 3. The cyclic transmission is a communication scheme to synchronize data stored in the memory included in each device in each consecutive cycle by performing communication in cycles to store common data into the memory. In the time slot TS0, another communication such as Internet Protocol (IP) communication may be performed. In another example, the time slot TS0 may be allocated with no communication and may be expandable in the future. The periods PR1 and PR2 have an equal length to allow cyclic communication in each time slot.

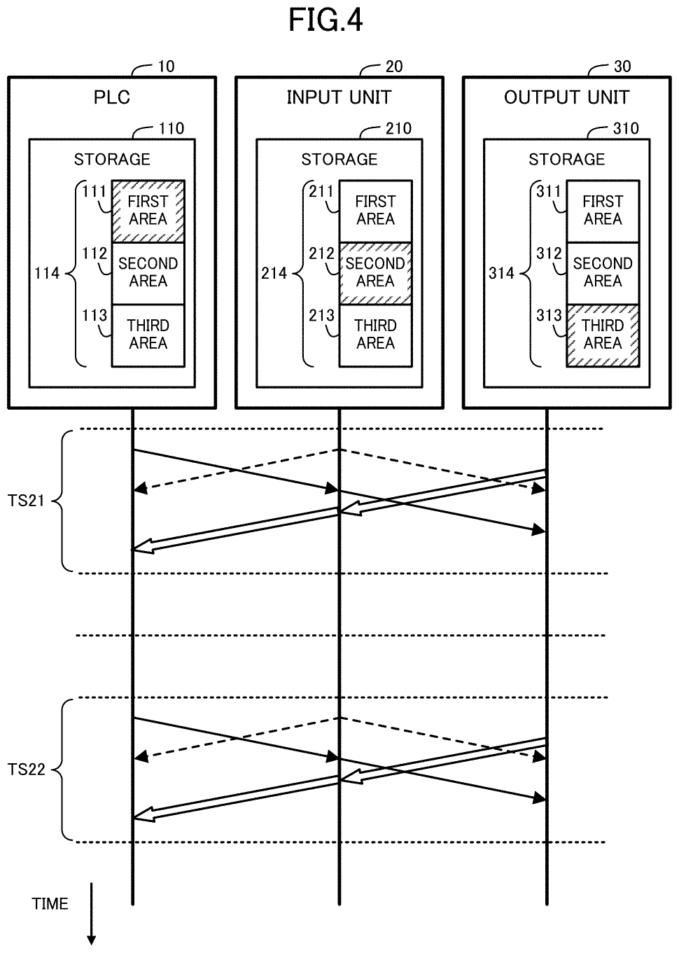

The cyclic transmission in the time slot TS2 is described with reference to FIG. 4. As illustrated in FIG. 4, the PLC 10 includes a storage 110, the input unit 20 includes a storage 210, and the output unit 30 includes a storage 310. The storage 110 is a component of the network unit 12 in the PLC 10. The storages 110, 210, and 310 are each implemented by at least one of the main storage 72 or the auxiliary storage 73.

The storage 110 includes a storage area 114 including a first area 111, a second area 112, and a third area 113. The storage 210 includes a storage area 214 including a first area 211, a second area 212, and a third area 213. The storage 310 includes a storage area 314 including a first area 311, a second area 312, and a third area 313. The first areas 111, 211, and 311 are allocated to the PLC 10, the second areas 112, 212, and 312 are allocated to the input unit 20, and the third areas 113, 213, and 313 are allocated to the output unit 30.

The PLC 10, the input unit 20, and the output unit 30 change data in the area allocated to the respective devices as appropriate. For example, the input unit 20 may store data TRUE indicating a high-level signal input from the input device 20A as input information into the second area 212. In FIG. 4, a hatched area is changeable independently of communication of each of the PLC 10, the input unit 20, and the output unit 30 with other devices.

Time slots TS21 and TS22 illustrated in FIG. 4 correspond to the time slot TS2 for cyclic transmission illustrated in FIG. 3, and are time segments belonging to different cycles. In the time slot TS21, the PLC 10 broadcasts or multicasts data stored in the first area 111 allocated to the PLC 10 to the other devices as indicated by solid arrows in FIG. 4. The input unit 20 broadcasts or multicasts data stored in the second area 212 allocated to the input unit 20 to the other devices as indicated by dashed arrows. The output unit 30 broadcasts or multicasts data stored in the third area 313 allocated to the output unit 30 to the other devices as indicated by outlined arrows.

The PLC 10 receives, in the time slot TS21, the data stored in the second area 212 in the input unit 20 at the start of the time slot TS21 and receives, in the time slot TS21, the data stored in the third area 313 in the output unit 30 at the start of the time slot TS21. The PLC 10 stores the data received from the input unit 20 into the second area 112 in the PLC 10 and stores the data received from the output unit 30 into the third area 113 in the PLC 10.

Similarly, the input unit 20 and the output unit 30 update data in the areas allocated to the other devices. More specifically, the input unit 20 receives, in the time slot TS21, the data stored in the first area 111 in the PLC 10 at the start of the time slot TS21 and receives, in the time slot TS21, the data stored in the third area 313 in the output unit 30 at the start of the time slot TS21. The input unit 20 stores the data received from the PLC 10 into the first area 211 in the input unit 20 and stores the data received from the output unit 30 into the third area 213 in the input unit 20.

The output unit 30 receives, in the time slot TS21, the data stored in the first area 111 in the PLC 10 at the start of the time slot TS21 and receives, in the time slot TS21, the data stored in the second area 212 in the input unit 20 at the start of the time slot TS21. The output unit 30 stores the data received from the PLC 10 into the first area 311 in the output unit 30 and stores the data received from the input unit 20 into the second area 312 in the output unit 30.

At the start of the time slot TS21, data in the storage areas 114, 214, and 314 may not match one another. When, for example, a signal input from the input device 20A is switched immediately before the time slot TS21, data stored in the second area 112 in the PLC 10 differs from the data stored in the second area 212 in the input unit 20. When the devices then provide data in the areas allocated to the respective devices to the other devices in the time slot TS21, the same data is stored into the storage areas 114, 214, and 314 at the end of the time slot TS21.

In the time slot TS22 as well, the data in the storage areas 114, 214, and 314 is synchronized similarly to the time slot TS21. The same time segments as in the time slots TS21 and TS22 are provided in constant cycles. Thus, the data in the storage areas 114, 214, and 314 is synchronized in each cycle. In other words, the transmission of the data stored in the storage areas 114, 214, and 314 between the devices is complete in the cycle. The input unit 20 can further transmit information to the output unit 30 by cyclic transmission to perform a control process in place of the PLC 10.

Although FIG. 4 typically illustrates a single input unit 20, a storage area in the control system 1000 including the input units 21 and 22 includes an area allocated to the input unit 21 and an area allocated to the input unit 22. In other words, parts of the storage areas are allocated to the respective devices sharing data by cyclic transmission through the network 40.

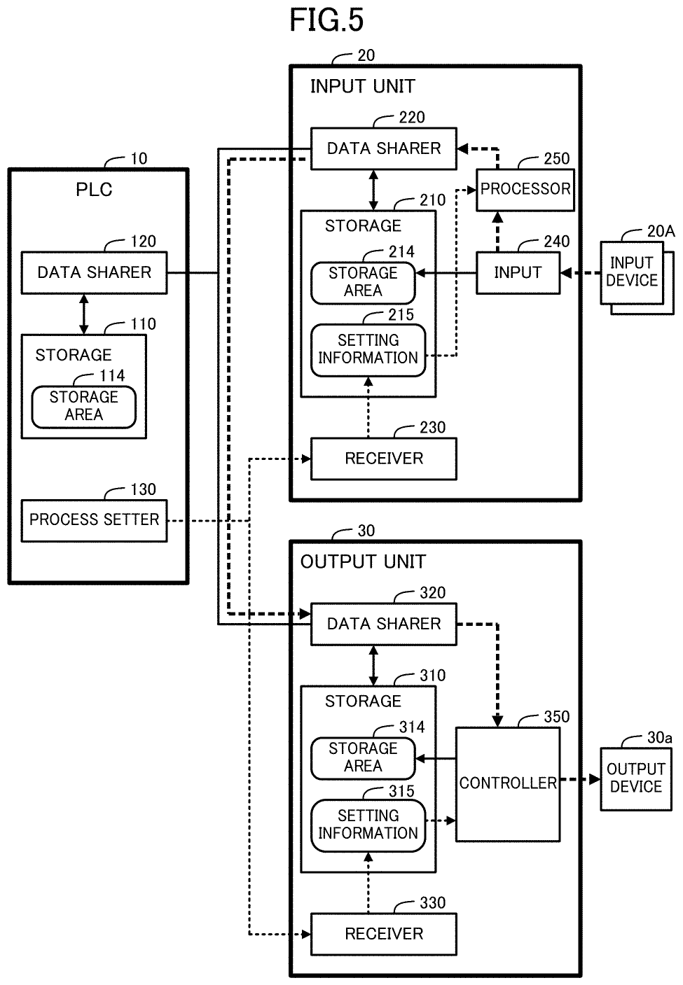

FIG. 5 is a functional block diagram of the PLC 10, the input unit 20, and the output unit 30. As illustrated in FIG. 5, the PLC 10 includes the storage 110 including the storage area 114, a data sharer 120 for sharing the data in the storage area 114 with the other devices by cyclic transmission, and a process setter 130 for setting a control process with the input unit 20 and the output unit 30.

The storage 110 and the data sharer 120 are included in the network unit 12 in the PLC 10. The data sharer 120 is mainly implemented by the processor 71 and the communicator 77 in the network unit 12 operating in cooperation with each other. The data sharer 120 synchronizes the data in the storage area 114 with data in the other devices by the cyclic transmission described above. More specifically, the data sharer 120 reads data in an area allocated to the PLC 10 in each time slot for cyclic transmission, transmits the read data to the other devices, receives data from the other devices, and writes the received data into the areas allocated to the respective other devices.

The process setter 130 is mainly implemented by the processor 71 and the communicator 77 in the CPU 11 operating in cooperation with each other. The process setter 130 receives the details of a process to be performed by the input unit 20 from the user and provides setting information indicating the details of the received process to the input unit 20. The process setter 130 receives the details of a process to be performed by the output unit 30 from the user and provides setting information indicating the details of the received process to the output unit 30.

The input unit 20 includes the storage 210 including the storage area 214, a data sharer 220 for sharing the data in the storage area 214 with the other devices by cyclic transmission, a receiver 230 for receiving setting information 215 from the PLC 10, an input 240 for acquiring input information input from the input device 20A, and a processor 250 for performing a computation process on the input information based on the setting information. The storage 210 corresponds to an example of first storage means including the storage area 214 as the first storage area in the input unit 20.

The data sharer 220 is mainly implemented by the processor 71 and the communicator 77 operating in cooperation with each other. The data sharer 220 synchronizes the data in the storage area 214 with data in the other devices by the cyclic transmission described above. The data sharer 220 transmits transmission information indicating the result of the computation process performed by the processor 250 to the output unit 30 by cyclic transmission. In other words, the data sharer 220 reads the transmission information indicating the result of the computation process from the storage area 214 and transmits the transmission information by cyclic transmission. The data sharer 220 corresponds to, in the input unit 20, an example of first data sharing means for sharing the data in the first storage area in the first storage means with the programmable controller and the output unit by, in a periodic time segment defined by the shared time, (i) transmitting data stored in an area allocated to the input unit in the first storage area to the programmable controller and the output unit, (ii) receiving the data from each of the programmable controller and the output unit, and (iii) storing the received data into an area allocated to each of the programmable controller and the output unit in the first storage area.

The receiver 230 is mainly implemented by the processor 71 and the communicator 77 operating in cooperation with each other. The receiver 230 stores the setting information 215 received from the process setter 130 in the PLC 10 into the storage 210.

The input 240 is implemented by a terminal for connection to the input device 20A or the communicator 77. The input 240 transmits the input information acquired from the input device 20A to the processor 250. The input 240 may store the acquired input information into the storage area 214 to provide the input information to the PLC 10 by cyclic transmission. The input 240 corresponds to, in the input unit 20, an example of input means for acquiring the input information input from the input device and storing the acquired input information into the area allocated to the input unit in the first storage area.

The processor 250 is mainly implemented by the processor 71. The processor 250 reads the setting information 215 from the storage 210 and performs a computation process indicated by the setting information 215 on the input information.

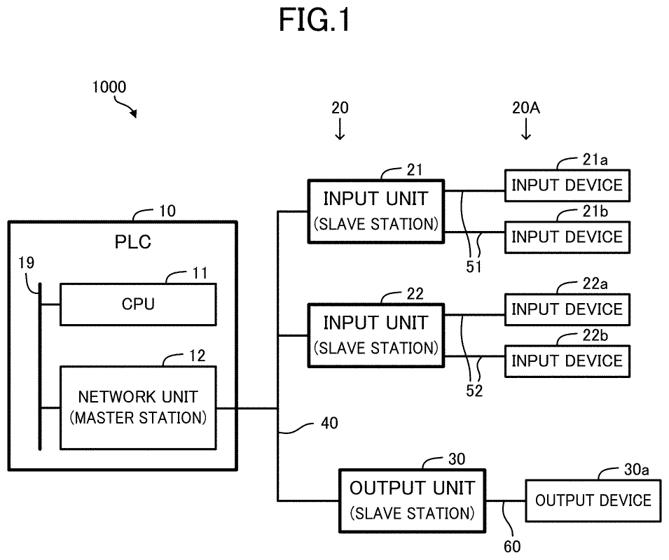

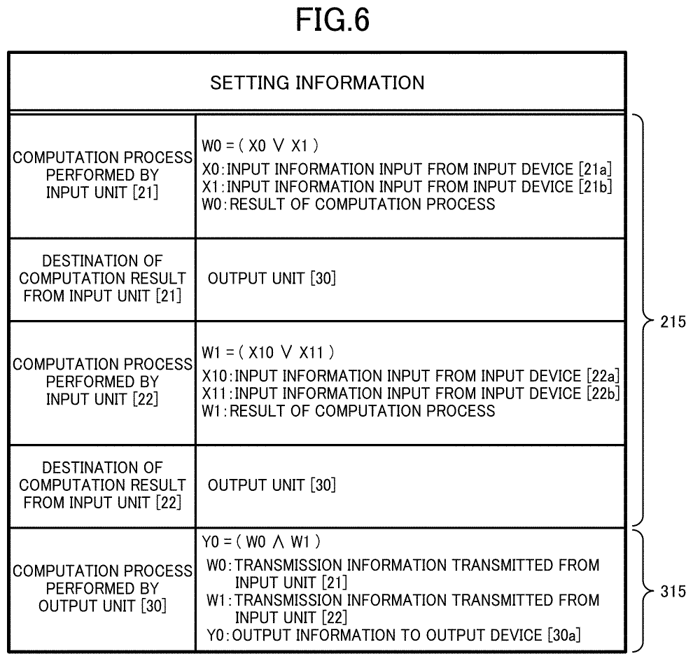

FIG. 6 is a diagram of example setting information provided from the PLC to the input unit 20 and the output unit 30. In FIG. 6, an input unit, an input device, an output unit, and an output device have the same reference numerals as the corresponding components illustrated in FIG. 1. For example, an input unit [21] in FIG. 6 corresponds to the input unit 21 in FIG. 1.

In the example illustrated in FIG. 6, the processor 250 in the input unit [21] performs a computation process of (X0∨X1) using input information X0 from an input device [21a] and input information X1 from an input device [21b]. In the above expression, X0 is an address for storing a TRUE value corresponding to a high-level signal or a FALSE value corresponding to a low-level signal from the input device 21a in the storage area 214 in the input unit 21, and X1 is an address for storing a TRUE value corresponding to a high-level signal or a FALSE value corresponding to a low-level signal from the input device 21b in the storage area 214 in the input unit 21. The computation written as (X0∨X1) is the logical OR of the value X0 and the value X1. In the example of FIG. 6, data W0 indicating the result of the computation is to be transmitted to an output unit [30]. For an input unit [22] as well, data W1 indicating the logical OR of input information X10 from an input device [22a] and input information X11 from an input device [22b] is to be transmitted to the output unit [30].

Referring back to FIG. 5, the processor 250 provides the result of the computation process to the data sharer 220. In the example of FIG. 6, the processor 250 in the input unit [21] transmits the value of the data W0 as the result of the computation process to the data sharer 220 and notifies that the output unit [30] is a destination of the information indicating the computation result.

After receiving the computation result from the processor 250, the data sharer 220 transmits transmission information indicating the computation result by cyclic transmission. In particular, the data sharer 220 transmits the transmission information to the output unit 30 and transmits the transmission information to the PLC 10. The data sharer 220 may transmit the transmission information as information written in the area allocated to the input unit 20 in the storage area 214. In other words, the processor 250 may write the computation result into the storage area 214, and the data sharer 220 may read the computation result from the storage area 214 and transmit the transmission information. The data sharer 220 may transmit the transmission information as information that differs from the information written in the area allocated to the input unit 20 in the storage area 214. The data sharer 220 may transmit the transmission information to the output unit 30 in a time segment for the cyclic transmission described above.

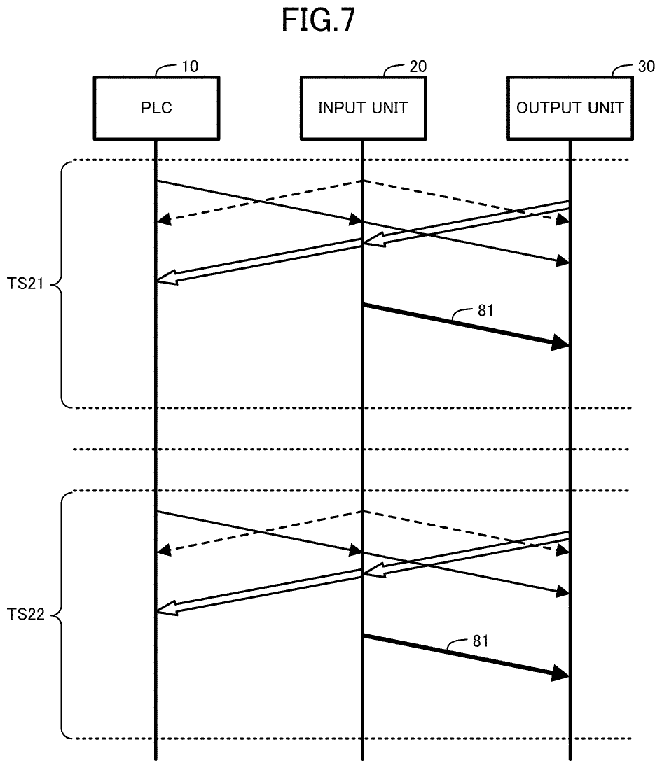

In FIG. 7, transmission information transmitted from the input unit 20 to the output unit 30 is indicated by arrows 81 in the time slots TS21 and TS22 for cyclic transmission. In the example of FIG. 7, the transmission information is transmitted in both the time slots TS21 and TS22. The data sharer 220 may transmit the transmission information when the computation result is changed. In the example described above, the data sharer 220 transmits the transmission information indicating the result of the computation process performed on the input information. However, when the setting information 215 indicates that the input information is to be transmitted without being changed to the output unit 30, the data sharer 220 may transmit the input information output from the input 240 as transmission information to the output unit 30 without a computation process being performed by the processor 250.

Referring back to FIG. 5, the output unit 30 includes the storage 310 including the storage area 314, a data sharer 320 for sharing the data in the storage area 314 with other devices by cyclic transmission, a receiver 330 for receiving setting information 315 from the PLC 10, and a controller 350 for controlling the output device 30a based on the transmission information using the setting information 315. The storage 310 corresponds to an example of storage means including the storage area 314 as a second storage area in the output unit 30.

The data sharer 320 is mainly implemented by the processor 71 and the communicator 77 operating in cooperation with each other. The data sharer 320 synchronizes the data in the storage area 314 with data in the other devices by the cyclic transmission described above. The data sharer 320 corresponds to, in the output unit 30, an example of second data sharing means for sharing the data in the storage area in the second storage means by, in the periodic time segment defined by the shared time, (i) transmitting data stored in the area allocated to the output unit in the second storage area to the programmable controller and the input unit, (ii) receiving the data from each of the programmable controller and the input unit, and (iii) storing the received data into an area allocated to each of the programmable controller and the input unit in the storage area.

The data sharer 320 receives the transmission information transmitted by the data sharer 220 in the input unit 20 and transmits the transmission information to the controller 350. When the transmission information is transmitted as information written in the storage area 214, the data sharer 320 may write the received transmission information into the area allocated to the input unit 20 in the storage area 314, and the controller 350 may read the transmission information written in the area.

The receiver 330 is mainly implemented by the processor 71 and the communicator 77 operating in cooperation with each other. The receiver 330 stores the setting information 315 received from the process setter 130 in the PLC 10 into the storage 310.

The controller 350 is mainly implemented by a terminal for connection to the output device 30a or the communicator 77 and the processor 71 operating in cooperation with each other. The controller 350 reads the setting information 315 from the storage 310 and performs a computation process indicated by the setting information 315 on the transmission information. The controller 350 outputs output information indicating the computation result to the output device 30a to control the output device 30a.

When, for example, the setting information 315 illustrated in FIG. 6 indicates the details of the computation process, the controller 350 in the output unit 30 outputs, as the output information, a high-level signal or a low-level signal corresponding to the logical AND of the value of the transmission information W0 received from the input unit [21] and the value of the transmission information W1 received from the input unit [22] to the output device 30a. The controller 350 stores the output information into the storage area 314 in the storage 310. The data sharer 320 then transmits the output information to the PLC 10 by cyclic transmission.

When the setting information 315 indicates that the transmission information from the input unit 20 is used as the output information without being changed, the controller 350 may skip the computation process. The controller 350 corresponds to an example of control means for controlling the output device based on the transmission information in the output unit 30.

FIG. 5 illustrates an information transmission path for controlling the output device 30a based on the input information from the input device 20A as indicated by a thick dashed arrow. As illustrated in FIG. 5, the transmission path is not through the PLC 10 and thus can cause a communication delay shorter than when the PLC 10 performs a control process.

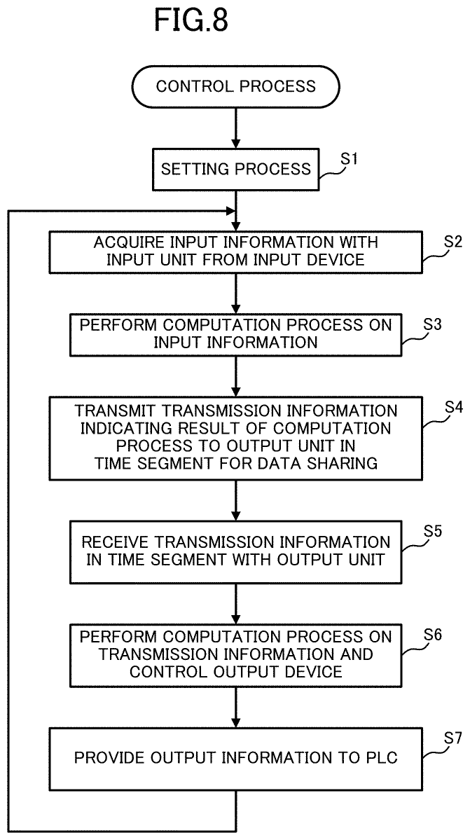

A control process performed in the control system 1000 is now described with reference to FIG. 8. FIG. 8 illustrates the control process performed by the input unit 20 and the output unit 30. The process illustrated in FIG. 8 is an example, with the order of steps being changeable as appropriate.

In the control process, the PLC 10 performs a setting process (step S1). More specifically, the process setter 130 receives, from the user, the parameter settings including input information to be input into the input unit 20, the details of a computation process to be performed by the input unit 20, the output unit 30 that is a destination of transmission information to be transmitted from the input unit 20, the details of a computation process to be performed by the output unit 30, and the output device controlled by the output unit 30, and provides the setting information 215 and the setting information 315 to the selected input unit 20 and the selected output unit 30.

Subsequently, the input 240 in the input unit 20 acquires the input information from the input device 20A (step S2), and the processor 250 performs the computation process on the acquired input information based on the setting information 215 set in step S1 (step S3). When the setting information 215 indicates that the input information is to be transmitted to the output unit 30 without being changed in step S1, step S3 may be skipped.

The data sharer 220 then transmits the transmission information indicating the result of the computation process in step S3 to the output unit 30 in a time segment for data sharing by cyclic transmission (step S4). When step S3 is skipped, the data sharer 220 transmits the input information acquired in step S2 as the transmission information without any change.

The output unit 30 then receives the transmission information in the same time segment as in step S4 (step S5). More specifically, the data sharer 320 in the output unit 30 receives the transmission information transmitted from a transmission source specified by the setting information 315.

The controller 350 then performs a computation process on the transmission information received in step S5 and controls the output device 30a (step S6). More specifically, the controller 350 outputs, to the output device 30a, output information acquired as the result of the computation process. When the setting information 315 indicates that the transmission information is to be output to the output device 30a without the computation process being performed in step S1, the computation process may be skipped in step S6.

In this case, the PLC 10 also receives the transmission information by cyclic transmission. In other words, the input unit 20 shares the input information or a result of the computation process performed on the input information with the PLC 10. Thus, the PLC 10 can acquire and monitor the progress of the control process set in the input unit 20 and the output unit 30 in real time. However, such monitoring may not be performed to reduce, for example, a computation load on the PLC 10.

The controller 350 then provides the output information output in step S6 to the PLC 10 (step S7). More specifically, the controller 350 stores the output information into the storage area 314, and the data sharer 320 provides the output information to the PLC 10 by cyclic transmission. The processing in step S2 and subsequent steps is then performed repeatedly.

As described above, the data sharer 220 shares the data with the PLC 10 and the output unit 30 in each periodic time segment and transmits the transmission information to the output unit 30 in each time segment. This allows data transmission between the devices as slave stations to be complete reliably within the cycles of the time segments, thus allowing more stable transmission of data at higher speed.

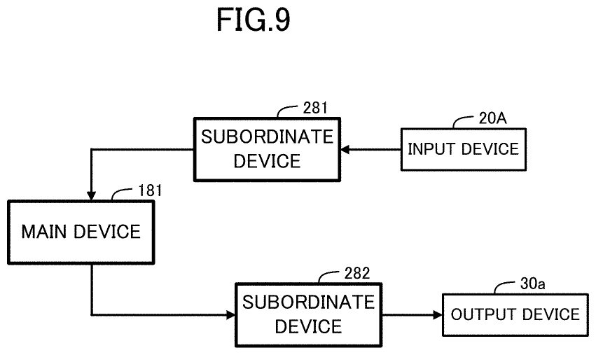

For example, FIG. 9 illustrates a transmission path of information used when a main device 181 as a master station acquires input information from the input device 20A through a subordinate device 281 as a slave station, performs a computation process on the acquired input information, and controls the output device 30a through a subordinate device 282. In this case, the transmission of information through a network occurs between the subordinate device 281 and the main device 181 and further occurs between the main device 181 and the subordinate device 282.

In the control system 1000 according to the embodiment, the transmission of information through the network 40 is performed between the data sharers 220 and 320 merely one time as indicated by the thick dashed arrow in FIG. 5. This allows the control process to be performed at higher speed than in the example of FIG. 9.

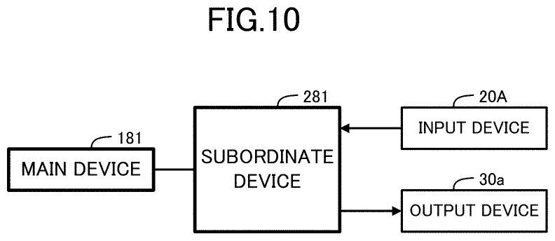

When the output device 30a connected to the subordinate device 281 is controlled based on the input information from the input device 20A connected to the same subordinate device 281 as illustrated in FIG. 10, the subordinate device 281 is preset to perform the control process. This structure allows high-speed control without involving a transmission delay. However, the input device 20A and the output device 30a are to be connected to the same subordinate device 281. This system configuration is usable in limited situations. In contrast, the control system 1000 according to the embodiment includes the input device 20A and the output device 30a connected to different slave stations and thus can be flexibly used for a variety of system configurations.

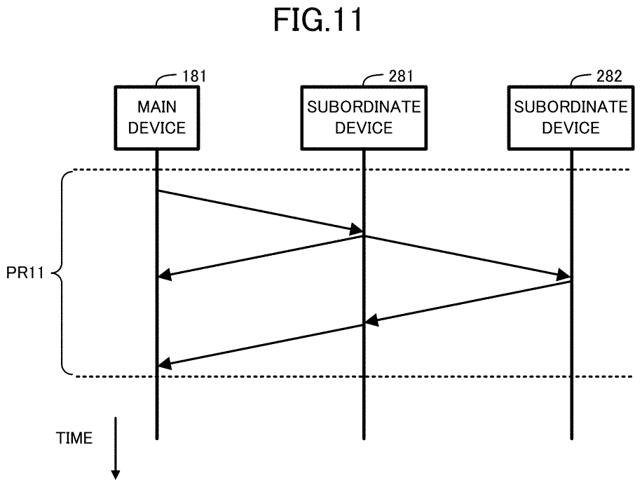

A method of cyclic transmission may be token passing as illustrated in FIG. 11. More specifically, a token corresponding to a right to transmit data is circulated through the devices in the network. Each of the devices holding the token transmits the data. The token is information about a predetermined right. A device holding the token transmits data, whereas a device holding no token does not transmit the data.

In the example of FIG. 11, the main device 181 holding a token first within a period PR11 broadcasts or multicasts data and outputs the token to the subordinate device 281. The subordinate device 281 waits until receiving the token, then broadcasts or multicasts the data, and outputs the token to the subordinate device 282. The subordinate device 282 waits until receiving the token, then broadcasts or multicasts the data, and returns the token to the main device 181. Periods similar to the period PR11 are thereafter repeated periodically.

In the control system 1000 according to the embodiment, the respective devices transmit data independently of whether data is received from the other devices in the time slot as illustrated in FIG. 4. This eliminates the wait for receiving a token. The cyclic transmission is complete in a short time to allow high-speed control.

### Embodiment 2

Embodiment 2 is now described focusing on the differences from Embodiment 1. The same reference signs denote the components that are the same as or similar to those in Embodiment 1. In Embodiment 1, the details of the processes to be performed by the input unit 20 and the output unit 30 are set by the user. However, this setting operation is complex when a larger number of devices are involved. The setting operation may be automated to reduce a burden on the user. In the example below, at least a part of the control process is performed by the input unit 20 and the output unit 30 based on information collected during the control process performed by the PLC 10.

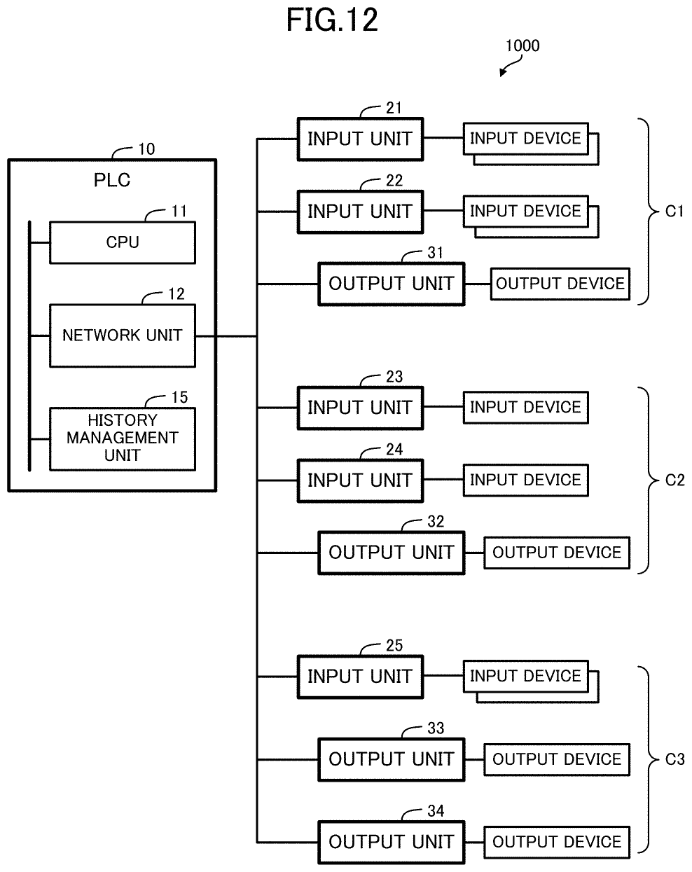

In the control system 1000 according to the embodiment, the PLC 10 is connected to input units 21 to 25 and output units 31 to 34 as illustrated in FIG. 12. Each of the input units 21 to 25 is hereafter referred to as the input unit 20 as appropriate, and each of the output units 31 to 34 is hereafter referred to as the output unit 30 as appropriate.

In addition to the CPU 11 and the network unit 12, the PLC 10 includes a history management unit 15 for managing the history of communication with the input unit 20 and with the output unit 30.

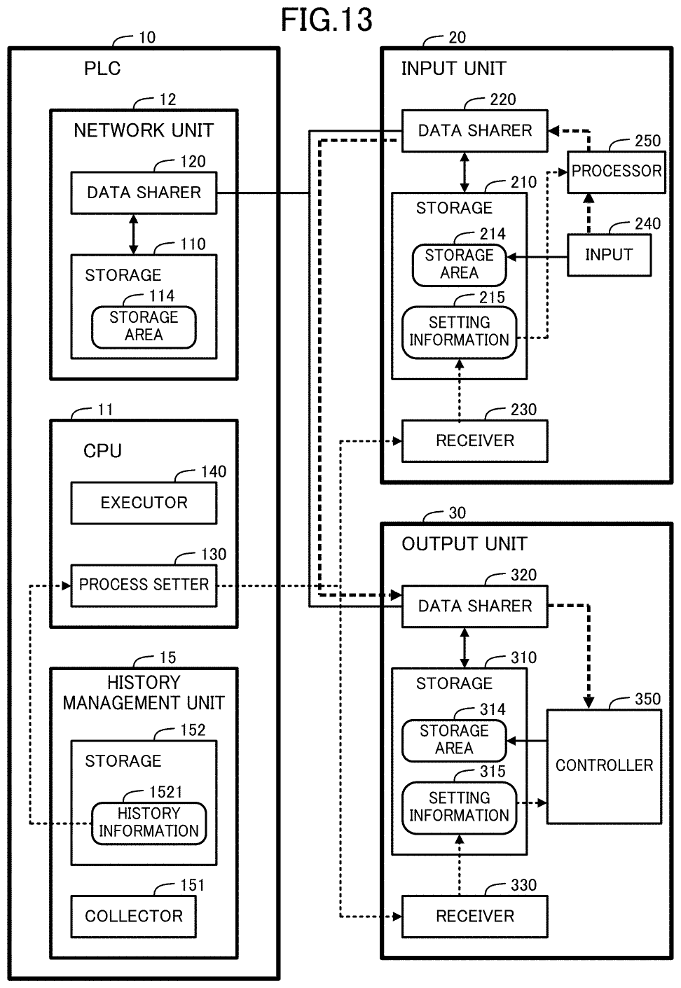

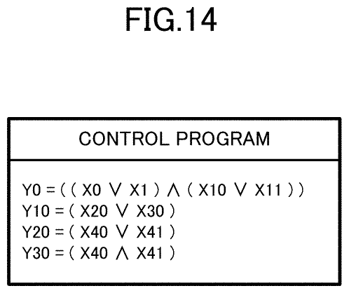

As illustrated in FIG. 13, the CPU 11 includes an executor 140 for executing a control program set by the user. The executor 140 is mainly implemented by the processor 71. FIG. 14 schematically illustrates the details of an example control program. In FIG. 14, a combination of X and a numeral indicates an address of input information, and a combination of Y and a numeral indicates an address of output information. In the expression, X0 and X1 are the addresses of areas allocated to the input unit 21, X10 and X11 are the addresses of areas allocated to the input unit 22, and Y0 is the address of an area allocated to the output unit 31. More specifically, the expression Y0=((X0∨X1)∧(X10∨X11)) on the first line indicates that the same control process as in Embodiment 1 is performed for a combination C1 of the input units 21 and 22 and the output unit 31 in FIG. 12.

In the expression, X20 is the address of an area allocated to the input unit 23, X30 is the address of an area allocated to the input unit 24, and Y10 is the address of an area allocated to the output unit 32. More specifically, the expression Y10=(X20∨X30) on the second line indicates a control process for a combination C2 of the input units 23 and 24 and the output unit 32 in FIG. 13.

In the expression, X40 and X41 are areas allocated to the input unit 25, Y20 is an area allocated to the output unit 33, and Y30 is an area allocated to the output unit 34. More specifically, the expression Y20=(X40∨X41) on the third line and the expression Y30=(X40∧X41) on the fourth line each indicate a control process for a combination C3 of the input unit 25 and the output units 33 and 34 in FIG. 12.

Referring back to FIG. 13, the history management unit 15 includes a collector 151 for collecting a communication history for the executor 140 in the CPU 11 executing the control program, and a storage 152 for storing history information 1521 about the collected communication history.

The collector 151 is mainly implemented by the processor 71 and the communicator 77 operating in cooperation with each other. When the executor 140 executes the control program, the collector 151 collects the data transmitted by the data sharer 120 and the data received by the data sharer 120. The collector 151 may monitor the data stored in the storage area 114 and collect the history of the data.

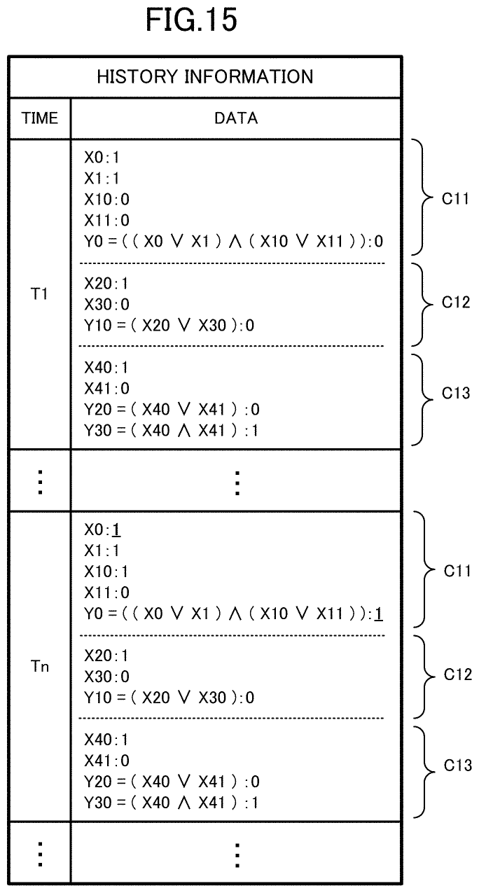

FIG. 15 illustrates example history information indicating the communication history collected by the collector 151. The history information associates time with the value of data at the time. FIG. 15 illustrates data C11 for the combination C1, data C12 for the combination C2, and data C13 for the combination C3 as indicated by dashed lines. A value changed from a past value is underlined for emphasis. More specifically, a value X0 at time Tn is changed from a value at the last time to 1, and a value Y0 is changed from a value at the last time to 1.

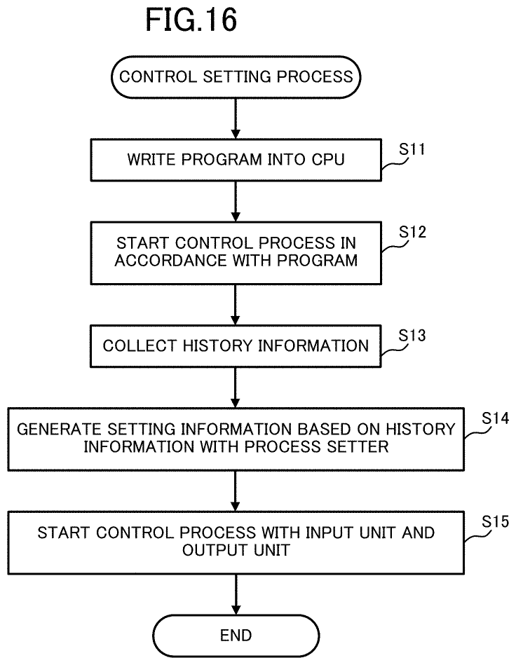

The process setter 130 in the CPU 11 selects, from the combinations C1 to C3, a combination with the highest frequency of data change by referring to the history information 1521. The process setter 130 performs setting to cause the input unit 20 and the output unit 30 in the selected combination to perform a control process for the combination. In the example of FIG. 16, the frequency of data change about the combination C1 is high. The same setting as in Embodiment 1 is thus performed for the input units 21 and 22 and the output unit 30.

The process setter 130 may perform setting to cause another combination to perform a control process. When, for example, the volume of communication from the input unit 20 to the output unit 30 as communication different from cyclic transmission increases excessively in a time slot for cyclic transmission, convergence occurs in the network 40. Thus, the process setter 130 may set a control process for multiple combinations in the decreasing order of the frequency of data change when communication in the time slot is allowed.

The executor 140 corresponds to, in the PLC 10, an example of execution means for performing, based on the input information input from the input device into at least one of a plurality of input units, a control process to control the output device connected to at least one of a plurality of output units. The storage 152 corresponds to an example of storage means for storing history information about histories of communication with the plurality of input units and communication with the plurality of output units in the control process performed by the execution means in the PLC 10. The process setter 130 corresponds to, in the PLC 10, an example of setting means for selecting a single input unit from the plurality of input units and a single output unit from the plurality of output units based on the history information, setting, with the single input unit, transmission of the transmission information to the single output unit based on the input information, and setting, with the single output unit, control of the output device based on the transmission information to cause the single input unit and the single output unit to perform at least a part of the control process.

FIG. 16 illustrates a control setting process to be performed by the control system 1000 according to the embodiment. The process illustrated in FIG. 16 is an example, with the order of steps being changeable as appropriate.

In the control setting process, the control program is written into the CPU 11 (step S11). More specifically, the CPU 11 acquires a ladder program provided by the user and writes the ladder program into the auxiliary storage 73 in the CPU 11.

The executor 140 then starts a control process in accordance with the control program written in step S11 (step S12). For example, the control program illustrated in FIG. 14 is executed. The executor 140 then performs a control process for each of all the combinations C1 to C3 a predetermined number of times or for a predetermined duration.

The collector 151 then collects the history information for communication in the control process started in step S12 (step S13). The process setter 130 generates setting information to be set in the input unit 20 and the output unit 30 based on the history information collected in step S13 (step S14). More specifically, the process setter 130 successively generates setting information for a combination with a higher frequency of data change than the other combination.

The input unit 20 and the output unit 30 then start the control process based on the setting information set in step S14 (step S15). For example, the input units 21 and 22 and the output unit 31 in the combination Cl start the control process on the first line in the control program in FIG. 15. When the setting information on the second to fourth lines is not generated, the control process on the second to fourth lines is subsequently performed by the executor 140. The control setting process is then complete.

As described above, the process setter 130 sets the setting information with the input unit 20 and the output unit 30 based on the history information. This can reduce the burden of a complex setting operation on the user.

The process setter 130 sets the setting information for the combination of the input unit 20 and the output unit 30 with a higher frequency of data change more preferentially than the other combinations. As the data changes, the output information changes. This can shorten the average response time taken before a change in the state of the input device is reflected in the output device.

Although one or more embodiments of the present disclosure have been described above, the present disclosure is not limited to the above embodiments.

For example, the time-division communication scheme may be a method in accordance with IEEE 802.1 TSN standard or another standard. In the example described above, one cycle includes three time slots. In some embodiments, one cycle may include one or two, or four or more time slots.

Although the example described above uses cyclic transmission when the controller 350 in the output unit 30 provides the output information to the PLC 10, the method for providing such information is not limited to this. For example, the controller 350 may set the PLC 10 as a destination and transmit data different from the data broadcasted for data sharing in a time slot for cyclic transmission. In a time slot different from the time slot for cyclic transmission, the output information may be provided.

In Embodiment 2, the PLC 10 includes the history management unit 15. However, the history management unit 15 is not limited to this. At least one of the CPU 11 or the network unit 12 may function as the history management unit 15, or the CPU 11 and the network unit 12 may be included in the PLC 10.

Although the PLC 10 as an example PLC includes multiple units attached to a base, the configuration is not limited to the above. For example, a controller that functions as the CPU 11 and the network unit 12 in a single housing may be used as the PLC 10.

In the example described above, the PLC 10 corresponds to the grand master for distributing a shared time. However, the grand master is not limited to the above. Either the input unit 20 or the output unit 30 may function as a grand master, and the PLC 10 that is a subordinate node may be synchronized with the time of the grand master. All the PLC 10, the input unit 20, and the output unit 30 may be synchronized with the time of another grand master as subordinate nodes.

The functions of the PLC 10, the input unit 20, and the output unit 30 can be implementable by dedicated hardware or a common computer system.

For example, the program P1 executable by the processor 71 may be stored in a non-transitory computer-readable recording medium for distribution. The program P1 is installed in a computer to provide a device that performs the above processing. Examples of such a non-transitory recording medium include a flexible disk, a compact disc ROM (CD-ROM), a digital versatile disc (DVD), and a magneto-optical (MO) disk.

The program P1 may be stored in a disk device included in a server on a communication network, typically the Internet, and may be, for example, superimposed on a carrier wave to be downloaded to a computer.

The above processing may also be performed by the program P1 being activated and executed while being transferred through a communication network.

The above processing may be performed by the program P1 being entirely or partially executed on a server device and a computer executing a program while transmitting and receiving information on the processing through a communication network.

In the system with the above functions implementable partially by the operating system (OS) or through cooperation between the OS and applications, portions executable by applications other than the OS may be stored in a non-transitory recording medium that may be distributed or may be downloaded to the computer.

Means for implementing the functions of the PLC 10, the input unit 20, and the output unit 30 are not limited to software, but may be implemented partially or entirely by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is usable for a system that controls devices through a slave station.

### Reference Signs List

1000 Control system
10 PLC
110, 152, 210, 310 Storage
111, 211, 311 First area
112, 212, 312 Second area
113, 213, 313 Third area
114, 214, 314 Storage area
120, 220, 320 Data sharer
130 Process setter
140 Executor
15 History management unit
1521 History information
181 Main device
19 System bus
20 to 25 Input unit
20A, 21a, 21b, 22a, 22b Input device
215, 315 Setting information
230, 330 Receiver
240 Input
250 Processor
281, 282 Subordinate device
30 to 34 Output unit
30a Output device
350 Controller
40 Network
51, 52, 60 Transmission path
70 FA device
71 Processor
72 Main storage
73 Auxiliary storage
74 Clock
75 Input
76 Output
77 Communicator
78 Internal bus
81 Arrow
C1 to C3 Combination
C11 to C13 Data
P1 Program
PR1, PR2, PR11 Period
TS0 to TS2, TS21, TS22 Time slot

1. An input unit connectable to a programmable controller and an output unit through a network and to an input device to share a shared time with the programmable controller and the output unit, the input unit comprising:
first data sharing circuitry to share data in a first storage area in a first storage with the programmable controller and the output unit by, in a periodic time segment defined by the shared time, (i) transmitting data stored in an area allocated to the input unit in the first storage area to the programmable controller and the output unit, (ii) receiving data from each of the programmable controller and the output unit, and (iii) storing the received data into an area allocated to each of the programmable controller and the output unit in the first storage area; and
input circuitry to acquire input information input from the input device and storing the acquired input information into the area allocated to the input unit in the first storage area, wherein
the first data sharing circuitry transmits, in the periodic time segment, transmission information to the output unit, and the transmission information is the input information or indicates a result of a predetermined computation process performed on the input information.

2. The input unit according to claim 1, wherein
the first data sharing circuitry transmits, in the periodic time segment, data stored in the area allocated to the input unit to the programmable controller and the output unit independently of whether data is received in the periodic time segment.

3. The input unit according to claim 1, wherein
the first data sharing circuitry transmits, to the output unit and the programmable controller, the transmission information indicating the result of the computation process performed on the input information as the data stored in the area allocated to the input unit in the first storage area.

4. A control system, comprising:
the input unit according to claim 1;
the programmable controller; and
the output unit, wherein
the output unit includes
second data sharing circuitry to share data in a second storage area in a second storage with the programmable controller and the input unit by, in the periodic time segment defined by the shared time, (i) transmitting data stored in an area allocated to the output unit in the second storage area to the programmable controller and the input unit, (ii) receiving data from each of the programmable controller and the input unit, and (iii) storing the received data into an area allocated to each of the programmable controller and the input unit in the second storage area, and
control circuitry to control an output device,
the second data sharing circuitry receives the transmission information transmitted by the input unit in the periodic time segment, and
the control circuitry controls the output device based on the received transmission information.

5. The control system according to claim 4, wherein
the control circuitry outputs output information to the output device based on the transmission information to control the output device, and
the second data sharing circuitry transmits the output information to the programmable controller.

6. The control system according to claim 4, comprising:
a plurality of the input units; and
a plurality of the output units, wherein
the programmable controller includes
execution circuitry to perform, based on the input information input from the input device into at least one of the plurality of input units, a control process to control the output device connected to at least one of the plurality of output units,
a storage to store history information about histories of communication with the plurality of input units and communication with the plurality of output units in the control process performed by the execution circuitry, and
setting circuitry to select a single input unit from the plurality of input units and a single output unit from the plurality of output units based on the history information, set, with the single input unit, transmission of the transmission information to the single output unit based on the input information, and set, with the single output unit, control of the output device based on the transmission information to cause the single input unit and the single output unit to perform at least a part of the control process.

7. A communication method to be implemented with an input unit connectable to a programmable controller and an output unit to share a shared time with the programmable controller and the output unit, the communication method comprising:
sharing data in a storage area in a storage with the programmable controller and the output unit by, in a periodic time segment defined by the shared time, (i) transmitting data stored in an area allocated to the input unit in the storage area to the programmable controller and the output unit, (ii) receiving data from each of the programmable controller and the output unit, and (iii) storing the received data into an area allocated to each of the programmable controller and the output unit in the storage area;
acquiring input information input from outside and storing the acquired input information into the area allocated to the input unit in the storage area; and
transmitting, to the output unit, in the periodic time segment, transmission information being the input information or indicating a result of a predetermined computation process performed on the input information.

8. A non-transitory computer-readable recording medium storing a program to be executed by an input unit connectable to a programmable controller and an output unit to share a shared time with the programmable controller and the output unit, the program causing the input unit to perform operations comprising:
sharing data in a storage area in a storage with the programmable controller and the output unit by, in a periodic time segment defined by the shared time, (i) transmitting data stored in an area allocated to the input unit in the storage area to the programmable controller and the output unit, (ii) receiving data from each of the programmable controller and the output unit, and (iii) storing the received data into an area allocated to each of the programmable controller and the output unit in the storage area;
acquiring input information input from outside and storing the acquired input information into the area allocated to the input unit in the storage area; and
transmitting, to the output unit, in the periodic time segment, transmission information being the input information or indicating a result of a predetermined computation process performed on the input information.
